(19) United States
(12) Patent Application Publication
(10) Pub. No.: US 2007/0263288 A1
(43) Pub. Date: Nov. 15, 2007

(54) Diffusive Reflecting Structure and Its Manufacturing Method, and Display Device Using It

(76) Inventor: Yusuke Tsubota, Minato-Ku (JP)

Correspondence Address: BIRCH STEWART KOLASCH & BIRCH, PO BOX 747, FALLS CHURCH, VA, 22040-0747, US

(21) Appl. No.: 11/666,819

(22) PCT Filed: Dec. 6, 2005
(86) PCT No.: PCT/IB05/54071

§ 371 Date: May 1, 2007

(30) Foreign Application Priority Data
Dec. 10, 2004 (JP) 2004-358868

(51) Int. Cl. G03C 5/00

(52) U.S. Cl. 359/599; 430/324

(57) ABSTRACT

An object of the invention is to obtain a diffusive reflecting structure showing a desired reflection directivity with ease and stability. The manufacturing method for a diffusive reflecting structure comprises: depositing a photosensitive material (2) on a base layer; masking the photosensitive material (2) using a halftone mask (3) having at least one of transmissive area (31) and light shield area (32) and having a semitransmissive area (33); forming unevenness (21, 22) on a surface of a layer of the photosensitive material by exposing the photosensitive material to light through the mask (3) and developing the material, the unevenness corresponding to peak portions corresponding to the one of the areas (31, 32) and halfway portions corresponding to the semitransmissive area; and depositing an optical reflecting material (4) on the formed uneven surface. The mask (3) comprises a stripe arrangement portion in the one or both of the transmissive area (31) and light shield area (32) and/or in the semitransmissive area (33) in order to transmit the incident light at a gray scale, the stripe arrangement portion having first linear parts (34) capable of transmitting incident light at a relatively high first transmittance and second linear parts (35) capable of intercepting incident light at a relatively low second transmittance, the first linear parts (34) and the second linear parts (35) being placed in parallel with each other alternately. A surface of a layer of the photosensitive material (2), corresponding to the stripe arrangement portion, is provided with small-scale bottom portions corresponding to ones (34) of the first and second linear parts and small-scale peak portions corresponding to the others (35).

### TECHNICAL FIELD

The present invention generally relates to a diffusive reflecting structure. The invention also relates to a manufacturing method for a diffusive reflecting structure and a display device using it. The invention particularly relates to a reflecting structure, its manufacturing method and display device using it, which can make diffused reflected light have a directivity.

### BACKGROUND ART

Patent Document 1 discloses a substrate for an electro-optical device designed to prevent reflected light from scattering in unnecessary directions and increase light intensity in necessary directions so as to improve display brightness in a viewing angle direction. More specifically, in reflective type and transflective type electro-optical device, a first resin layer is provided with an inclined structure necessary to make reflected light have a directivity, a second resin layer is disposed on the inclined structure and a reflecting plate is disposed on the second resin layer. Such an inclined structure is formed using a photolithography method, wherein a halftone mask is used as a photomask, or elliptic, circular and droplet shape is used for a mask pattern. According to this substrate, improvement of display brightness in the viewing angle direction is realized by optimizing the inclined structure using the photomask.

However, the technique described in this Patent Document is based on a complicated manufacturing process of forming the first resin layer for defining a reflection directivity with relying on the inclined structure and the second resin layer which performs a principal light scattering function separately. Furthermore, forming a relatively fine uneven body as the second resin layer on the inclined structure of the first resin layer results in an aspect where stability is not sufficient to secure the desired diffusivity.

On the other hand, there is a report that a reflective type color TFT-LCD having a high reflectance (42%) and high contrast ratio (80:1) has been developed using a vertically aligned (VA) liquid crystal (Non-Patent Document 1). This Non-Patent Document also reports that an MVA (Multi-domain Vertical Alignment) liquid crystal is adopted as the VA liquid crystal and a low-cost, high display performance reflective type color TFT-LCD has been successfully implemented using wrinkled diffusive reflecting electrodes obtained through a newly developed photomask-less process.

This wrinkled crease diffusive reflecting electrode is formed as follows. A photosensitive resin layer is formed on a TFT substrate, subjected to exposure to light using a photomask for forming contact holes and developed to form contact holes. Next, the remaining resin is irradiated with UV light without any photomask. On this occasion, a distribution of contraction percentages is made in a single layer of photosensitive resin by adjusting the UV intensity and spectral characteristic so that a contraction percentage is greater in the lower layer portion than in the upper layer portion. Then, in order to cause the resin having the contraction percentage distribution in a thickness direction to be contracted, wrinkle-like asperity is formed on the surface using a baking process and finally a metal layer having a high optical reflectance, such as Al is formed on this wrinkle-like asperity surface to create diffusive reflecting electrodes having similar wrinkle-like asperity surfaces.

This Non-Patent Document also refers to control of a reflection characteristic based on a direction of the wrinkle-like asperity. This specifies that it is possible to cause incident light to be reflected only at a specific azimuth by controlling the direction of the wrinkle-like asperity. More specifically, a reflection characteristic of a directivity in which a higher reflectance appears in the vertical and horizontal directions is obtained by varying conditions of an interface between the photosensitive resin layer and the substrate to control directions of the wrinkle-like asperity.

However, the shape of the wrinkle-like asperity largely depends on not only the thickness of the photosensitive resin and UV irradiation energy but also various other manufacturing parameters and it is well imaginable that a desired shape can not be easily made reliably. Moreover, even if optimum parameters are found and manufacturing is performed according to these parameters, it is often the case that unexpected fluctuations of parameters occur in the actual manufacturing flow, making it impossible to form the desired shape stably and particularly making it more likely to produce variations among products.

[Patent Document 1] Japanese Patent Application Laid-Open No. 2004-37946 (see especially claims, paragraph Nos. [0023] to [0034] and FIGS. 1 and 2)

[Non-Patent Document 1] Norio Sugiura and three authors, “Reflective Type Color TFT-LCD using MVA Technique”, liquid crystal Vol. 6, No. 4, 2002, Japanese Liquid Crystal Society, published on Oct. 25, 2002, P. 383-389

### DISCLOSURE OF INVENTION

Technical Problem

The present invention has been implemented in view of the above-described circumstances, and its object is to provide a manufacturing method that can obtain a diffusive reflecting structure showing a desired reflection directivity with ease and stability. Another object of the invention is to provide a diffusive reflecting structure and a display device using it, which can be stably produced in a simple manufacturing process.

Technical Solution

In order to attain the above-mentioned objects, a first aspect of the invention is a manufacturing method for a diffusive reflecting structure, comprising: a first step of depositing a photosensitive material on a base layer; a second step of masking the photosensitive material using a halftone mask having at least one of transmissive area and light shield area and having a semitransmissive area; a third step of forming unevenness on a surface of a layer of the photosensitive material for providing an optical diffuse reflecting property by exposing the photosensitive material to light through the mask and developing the material, the unevenness corresponding to peak portions corresponding to the one of the transmissive area and light shield area and halfway portions corresponding to the semitransmissive area; and a fourth step of depositing an optical reflecting material on the formed uneven surface, wherein the halftone mask comprises a stripe arrangement portion in the one or both of the transmissive area and light shield area and/or in the semitransmissive area in order to transmit the incident light at a gray scale, the stripe arrangement portion having first linear parts capable of transmitting the incident light at a relatively high first transmittance and second linear parts capable of intercepting the incident light at a relatively low second transmittance, the first linear parts and the second linear parts being placed in parallel with each other alternately, and a surface of a layer of the photosensitive material, corresponding to the stripe arrangement portion, is provided with small-scale bottom portions corresponding to ones of the first and second linear parts and small-scale peak portions corresponding to the others.

By so doing, it is possible to form peak portions and halfway portions which are lower than the peak portions, namely, relatively large-scale unevenness for providing an optical diffuse reflecting property, on a surface of a layer of the photosensitive material which is a base layer of the optical reflecting material. Moreover, it is possible to form fine unevenness corresponding to the linear parts of the halftone mask on the peak portions or halfway portions in the same patterning process of the photolithography method used to form the large-scale unevenness, and this fine unevenness can determine superiority or inferiority in the distribution of the reflected light intensity. Therefore, it is possible to manufacture a diffusive reflecting structure showing a desired reflection directivity with ease and stability.

In this aspect, a surface of a layer of the photosensitive material may also be provided with a bottom portion corresponding to the other of the transmissive area and light shield area in the third step. This allows the bottom portion which is lower than the halfway portion to be formed on the surface of the layer of the photosensitive material, making it possible to realize a more complicated uneven pattern and also add the bottom portion suitable for the applied device to the uneven surface. Here, the base layer may include a layer forming a transistor, other active element or signal transmission path, the photosensitive material may be electrically insulative, the bottom portion may form a through hole for causing a signal output electrode of the active element or the signal transmission path to be exposed to the exterior and/or a local optical transmissive area of the reflecting structure, and the optical reflecting material may be electrically conductive. This is suitable for forming the reflecting structure on the base layer including an active element or signal transmission path or for forming the reflecting structure which locally transmits light.

It is desirable that linear parts of the stripe arrangement portion extend in a direction perpendicular to a direction in which dominance should be made in distribution of diffuse reflection of the diffusive reflecting structure. The light reflected by the reflecting structure obtained in this way has higher intensity in the direction perpendicular to the extending direction of the small-scale bottom portion and peak portion than in the extending direction. Furthermore, linear parts of the stripe arrangement portion in at least one of the transmissive area and light shield area and linear parts of the stripe arrangement portion in the semitransmissive area may also extend in parallel with or perpendicularly to each other or at predetermined angles. This makes it possible to enhance a directivity in one direction or obtain various types of cross-figured directivity.

Furthermore, in correspondence with the above-mentioned manufacturing method, a second aspect of the present invention is a diffusive reflecting structure, comprising a layer of a photosensitive material that is formed integrated on a base layer and has a surface with uneven pattern representing peak portions and valley portions for providing an optical diffuse reflecting property and a layer of an optical reflective material deposited on the surface with the uneven pattern, wherein at least one of the peak portion and valley portion is provided with linear small-scale bottom portions and small-scale peak portions formed in parallel with each other alternately. The advantages offered by such a diffusive reflecting structure is as described above. Likewise, there can be introduced: an implementation where the base layer includes a layer forming a transistor, other active element or signal transmission path, the photosensitive material is electrically insulative, the valley portion includes a through hole for causing a signal output electrode of the active element or the signal transmission path to be exposed to the exterior and/or a portion forming a local optical transmissive area of the reflecting structure, and the optical reflecting material is electrically conductive; an implementation where the small-scale bottom portions and peak portions extend in a direction perpendicular to a direction in which dominance should be made in distribution of diffuse reflection of the diffusive reflecting structure; and an implementation where the small-scale bottom portions and peak portions in the peak portion and the small-scale bottom portions and peak portions in the valley portion extend in parallel with or perpendicularly to each other or at predetermined angles.

A further aspect of the present invention is a display device using a diffusive reflecting structure, wherein the diffusive reflecting structure functions as diffusive reflection of light according to an image to be displayed in the display device. By defining the extending directions of the above-described small-scale bottom portion and peak portion, a desired directivity can be obtained in the display device to which the invention is applied. Furthermore, by simplifying the manufacturing process for the diffusive reflecting structure as already described, it is possible to provide a low-cost display device. Here, the layer of optical reflective material can serve as a row or column electrode, common electrode, or pixel electrode according to the display device to which the invention is applied.

### BRIEF DESCRIPTION OF DRAWINGS

FIG. 1 is a cross-sectional view of a diffusive reflecting structure for explaining a first process in a manufacturing method for the structure according to one embodiment of the invention.

FIG. 2 is a cross-sectional view of a diffusive reflecting structure for explaining a second process in a manufacturing method for the structure according to one embodiment of the invention.

FIG. 3 is a cross-sectional view of a diffusive reflecting structure for explaining a third process in a manufacturing method for the structure according to one embodiment of the invention.

FIG. 4 is a plan view schematically showing a pattern of a halftone mask used in one embodiment of the invention.

FIG. 5 is a cross-sectional view of a diffusive reflecting structure for explaining a fourth process in a manufacturing method for the structure according to one embodiment of the invention.

FIG. 6 is a cross-sectional view of a diffusive reflecting structure for explaining a fifth process in a manufacturing method for the structure according to one embodiment of the invention.

FIG. 7 is a cross-sectional view of a diffusive reflecting structure for explaining a sixth process in a manufacturing method for the structure according to one embodiment of the invention.

FIG. 8 is a cross-sectional view showing a configuration of a modified diffusive reflecting structure according to the invention.

FIG. 9 is a graph showing reflection distribution of a diffusive reflecting structure according to a comparison example.

FIG. 10 is a graph showing reflection distribution of a diffusive reflecting structure according to one embodiment of the invention.

FIG. 11 is a general plan view of a halftone mask used to form a diffusive reflecting structure according to a comparison example.

FIG. 12 is a general plan view of a halftone mask used to form a diffusive reflecting structure according to one embodiment of the invention.

FIG. 13 is a graph showing reflection distribution of a diffusive reflecting structure of a modification according to the invention.

FIG. 14 is a general plan view of a halftone mask used to form a diffusive reflecting structure of a modification according to the invention.

FIG. 15 is a graph showing reflection distribution of a diffusive reflecting structure of another modification according to the invention.

FIG. 16 is a general plan view of a halftone mask used to form a diffusive reflecting structure of another modification according to the invention.

FIG. 17 is a graph showing reflection distribution of a diffusive reflecting structure of a further modification according to the invention.

### BEST MODE FOR CARRYING OUT THE INVENTION

With reference now to the attached drawings, the above-mentioned aspects and other implementations of the present invention will be described in more detail by way of embodiment.

### EMBODIMENT

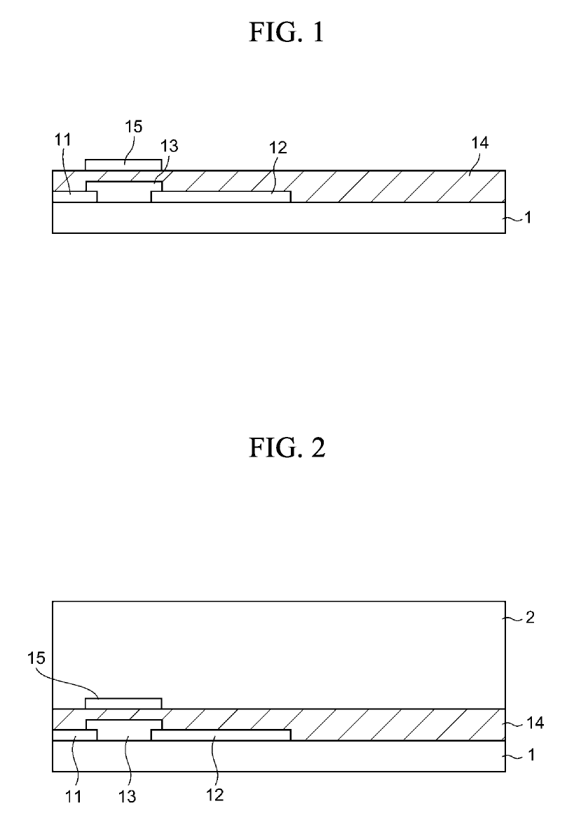

FIGS. 1 to 6 show a summary of steps in the manufacturing method of a diffusive reflecting structure for a display device according to an embodiment of the present invention.

FIG. 1 shows the cross-sectional structure of a base layer immediately before starting a manufacturing process of a diffusive reflecting structure. The base layer in this embodiment is constructed of a glass substrate 1, a source electrode layer 11 and a drain electrode layer 12 formed on the glass substrate 1 with a certain space provided in between, a semiconductor layer 13 bridged between these electrode layers, an insulating layer 14 made of, for example, inorganic compound, serving as a so-called gate insulating film and laminated so as to cover these layers 11-13, and a gate electrode layer 15 formed on the insulating layer 14 in correspondence with the area of the semiconductor layer 13 between the source electrode layer 11 and the drain electrode layer 12. In this embodiment, the source electrode layer 11, drain electrode layer 12, semiconductor layer 13, insulating layer 14 and gate electrode layer 15 constitute a thin-film transistor for driving a pixel. FIG. 1 shows only an excerpt of the structure of one transistor for simplicity of description, but the same structure is formed for all pixels over the entire principal surface of the diffusive reflecting structure. The following descriptions will also follow the same purport.

Next, a photosensitive material 2 made of, for example, organic compound is deposited on the entire surface of this base layer through an application process such as spin coating. FIG. 2 shows this situation. The photosensitive material 2 serves as a foundation or base of the diffusive reflecting structure, and as the material 2, a photosensitive as well as electrically insulative material is used to make electrical isolation from the underlying transistors. More specifically, material such as an acrylic base resin is used.

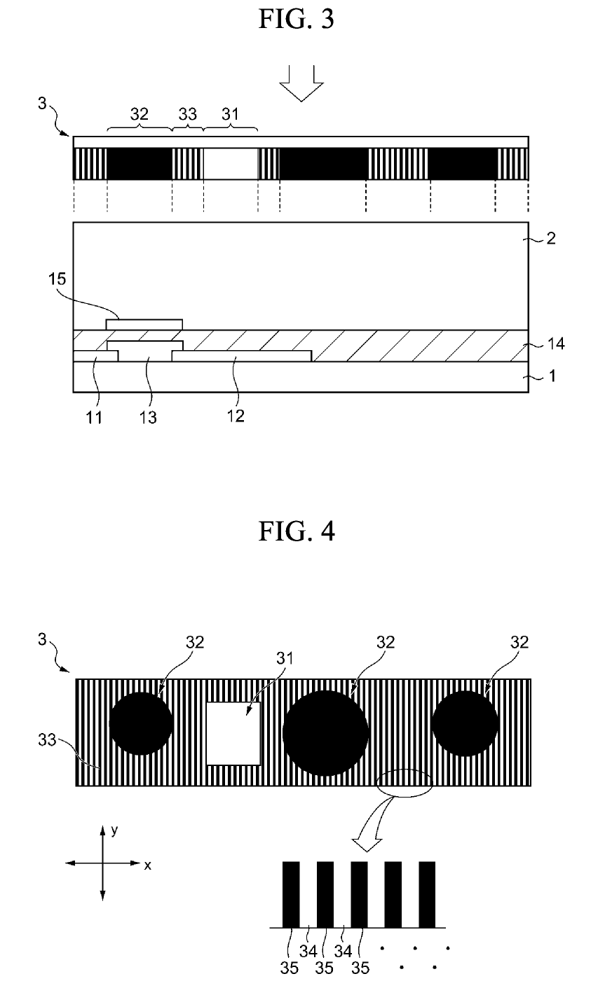

After applying necessary processes such as baking, the deposited photosensitive material 2 is masked using a halftone mask from the front side. FIG. 3 shows this situation. The halftone mask 3 used comprises a transmissive area 31, a light shield area 32 and a semitransmissive area 33 as its principal areas. In FIG. 3, these areas are symbolically expressed with blank, black and stripe, respectively.

FIG. 4 shows a planar structure of the halftone mask 3 corresponding to the respective area patterns of the cross section in FIG. 3. FIG. 4 also expresses these parts with blank, black and stripe, respectively. As shown in a partially enlarged view at the bottom of FIG. 4, in order to transmit incident light at a gray scale (e.g., at an average transmittance 50%), the semitransmissive area 33 of the halftone mask 3 is constructed of first linear parts 34 capable of transmitting the incident light at a relatively high, first transmittance and second linear parts 35 capable of intercepting the incident light at a relatively low, second transmittance, the first linear parts 34 and the second linear parts 35 being placed in parallel with each other alternately. In this embodiment, the first linear part 34 is made up of a portion which transmits the incident light substantially completely (at a transmittance 100%) and the second linear part 35 is made up of a portion which intercepts the incident light substantially completely (at a transmittance 0%). These linear parts 34, 35 are designed to extend in the vertical direction (y-direction) of the principal surface when the finished diffusive reflecting structure is used and viewed from its front.

It should be noted that the halftone mask 3 is not of a type that transmits incident light at a gray scale based on a fact that the entire semitransmissive area exhibits an intermediate transmittance by changing halfway the thickness and material of the halftone mask 3 in the semitransmissive areas with respect to the transmissive and light shield areas. The halftone mask 3 in the present invention is of a so-called diffraction type and characterized by its stripe arrangement based on a mixed arrangement of linear areas having different transmittances as described above.

When the photosensitive material 2 is exposed to light through such a halftone mask 3, incident light passes through the transmissive area 31 as is, incident light is intercepted substantially completely in the light shield area 32 and incident light transmits at a gray scale in the semitransmissive area 33 (that is, its light intensity is reduced approximately by half). Accordingly, the photosensitive material 2 exhibits light receiving states corresponding to the areas 31, 32, 33 respectively. A portion corresponding to the transmissive area 31 becomes soluble to a developer which will be applied later, a portion corresponding to the light shield area 32 maintains sufficient solvent-resistance to the developer and a portion corresponding to the semitransmissive area 33 becomes semi-soluble or semi-solvent-resistant.

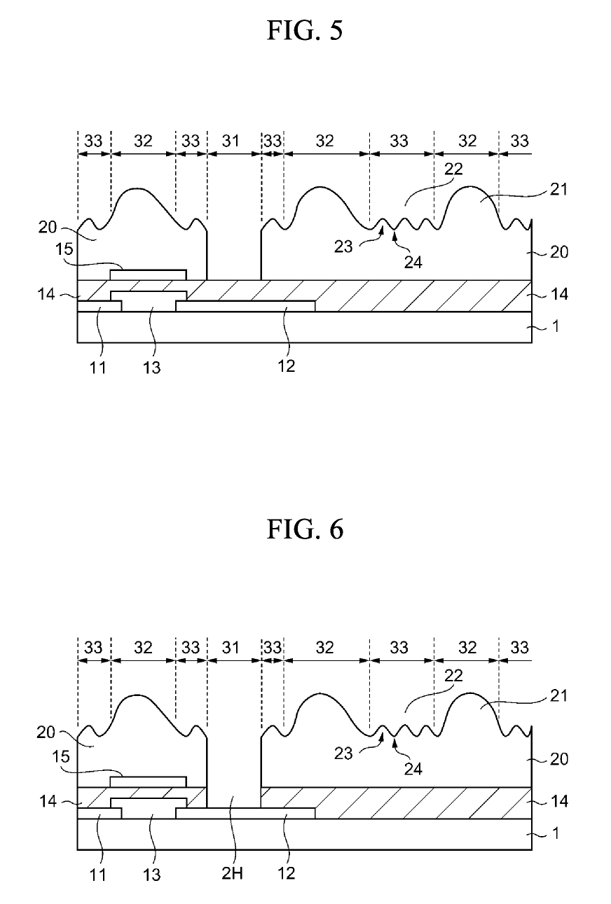

After the exposure to light, the exposed photosensitive material 2 is subjected to a developing process using a predetermined developer. By so doing, as generally shown in FIG. 5, a layer 20 of a photosensitive material with unevenness formed on the surface is obtained. After the development, the photosensitive material 2 is subjected to a baking process, etc.

The transmissive area 31 of the halftone mask 3 is provided to form a contact hole for a transistor in the base layer, for example the drain electrode layer 12, and in the stage of FIG. 5, the insulating layer 14 is exposed to the exterior in the area of the contact hole as a first step. That is, the layer 20 of the photosensitive material in this stage is formed so as to cover the insulating layer 14 in areas other than the area of the contact hole. In this situation, an etching process is performed using a predetermined etching gas, for example. The layer 20 of the photosensitive material is corrosion-resistant to the etchant, whereas only a portion of the insulating layer 14 in the exposed area is etched. In this way, all the portions of the photosensitive material 2 and insulating layer 14 corresponding to the transmissive area 31 are removed after the etching and a through hole 2H where a drain electrode layer 12 is exposed to the exterior is formed as shown in FIG. 6.

The light shield area 32 of the halftone mask 3 is provided to form a projection portion on the surface of the photosensitive material 2, and the photosensitive material 2 is substantially not irradiated with light incident upon the light shield area 32 in principle, and therefore the photosensitive material 2 keeps its solvent-resistance. However, since diffraction of incident light or leakage of light occurs in the vicinity of the boundary of the light shield area 32, that part of the photosensitive material 2 is subject to a greater amount of irradiation compared to the center area of the light shield area 32. As a result, a mountain-like projection portions 21 are formed, in which the respective peak portions can be observed as generally shown in FIG. 6. The shape (similar to an upside down bowl) of the projection portion 21 shown in FIG. 6 is only an example and this does not exclude other shapes including a shape, the cross section of the peak portion of which is relatively flat like a trapezoid.

The semitransmissive area 33 of the halftone mask 3 is provided to form depression portions on the surface of the photosensitive material 2. Light incident upon the semitransmissive area 33 is applied to the photosensitive material 2 at a gray scale and the photosensitive material 2 is etched and remains to an extent corresponding to a level of the gray scale. Thus, depression portions 22 are formed where bottom or valley portions of intermediate heights with respect to the projection portions 21 can be observed between the projection portions 21 and between the projection portion 21 and the through hole 2H. FIG. 6 only shows an example of the shape of the depression portion 22. The depression and projection portions 21, 22 are required to have uneven patterns capable of diffusing and reflecting incident light when an optical reflective material is laid thereon, and the respective area patterns of the halftone mask 3 are formed so as to satisfy this requirement.

Further in the depression portion 22, a specific uneven surface is formed by the stripe arrangement in the above-described semitransmissive area 33. The first linear part 34 in the stripe arrangement, which allows incident light to transmit therethrough almost completely, is limited to an extremely small area as compared to the transmissive area 31. On the other hand, the second linear part 35, which intercepts incident light almost completely, is limited to an extremely small area as compared to the light shield area 32. By virtue of such areal limitation of the transmissive and light shield areas, the depression portion 22 having an intermediate average height is formed and micro depression and projection portions 23, 24 are formed on the bottom face of the depression portion 22 as shown in FIG. 6. The first linear part 34 forms the depression portion 24 where a small-scale bottom or valley portion can be observed, while the second linear part 35 forms the projection portion 23 where a small-scale peak portion can be observed.

Such micro depression and projection portions 23, 24 can be formed accurately by selecting appropriate manufacturing parameters which define a specific manner in the photolithography method including widths of the linear parts 34, 35 in the semitransmissive area 33, exposure power and time, developer concentration, type of the photosensitive material 2 and more.

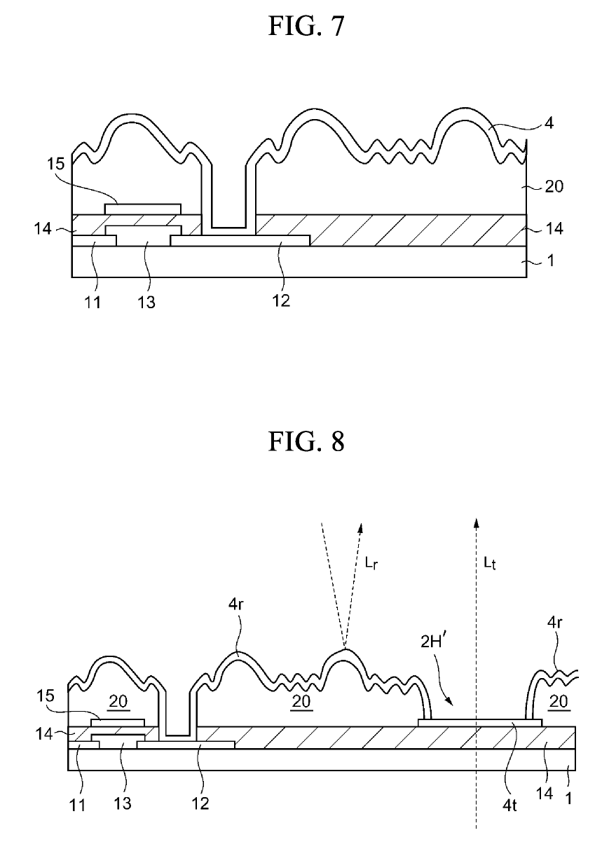

After the base layer 20 of the photosensitive material as shown in FIG. 6 is completed, necessary processes such as cleaning and baking are carried out and then the optical reflective material 4 is deposited thereon (FIG. 7). For the optical reflective material 4, an electrically conductive material such as aluminum is adopted, and the material 4 is adhered and deposited to not only the surface of the base layer 20 but also the exposed surfaces of the insulating layer 14 and drain electrode layer 12. In this way, the optical reflective material 4 forms electrical connection with the drain electrode layer 12 of the transistor formed on the base layer and also functions as a diffusive reflecting plate on the upper layer of the transistor. In this embodiment, the optical reflective material 4 also functions as a pixel electrode and is subjected to patterning so as to be a divisional area into area corresponding to a pixel area in the later processes. The deposited optical reflective material 4 exhibits unevenness according to a variety of unevenness of the surface of the base layer 20 as generally shown in FIG. 7.

It is possible to form the base layer 20 in which the through hole 2H, depression and projection portions 21, 22 in the principal area and micro depression and projection portions 23, 24 in a sub-area occupied by the depression portion 22 are integrated and formed through only one procedure of patterning in photolithography, and therefore it is possible to easily manufacture a diffusive reflecting structure. Moreover, the micro depression and projection portions 23, 24 play a role of defining a reflection directivity of the diffusive reflecting structure, described later, and so it is convenient.

The structure shown in FIG. 7 is directed to a diffusive reflecting structure provided on the base layer in which a field effect type transistor is formed, but the transistor can be replaced by another type of active element, or a diffusive reflecting structure may be provided on the base layer in which a signal transmission path other than the active element is formed. Furthermore, the base layer is not always limited to a form provided with an active element or signal transmission path. Besides, the layer 4 of the optical reflective material serves not only as a pixel electrode but also, as, for example, a row or column electrode or a common electrode of a passive type liquid crystal display panel.

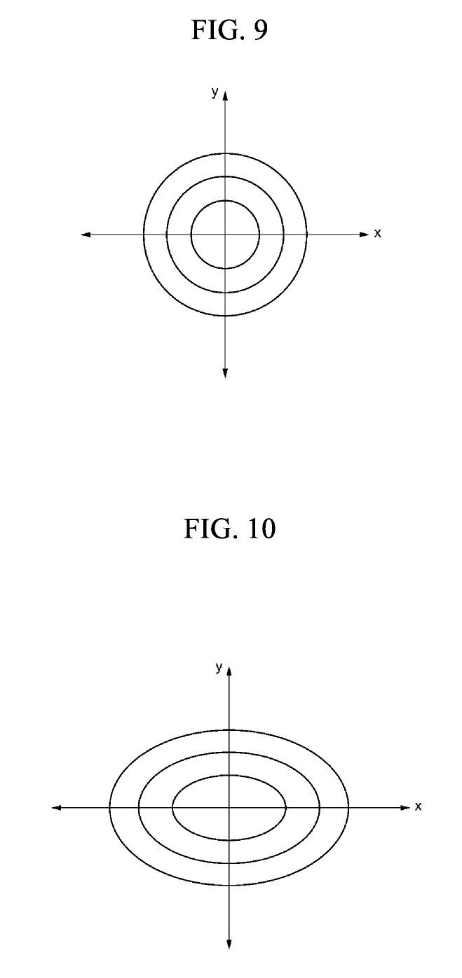

Furthermore, it is also applicable to a structure of a pixel electrode in a so-called transflective type liquid crystal display panel as described in M. Kubo, et al. “Development of Advanced TFT with Good Legibility under Any Intensity of Ambient Light”, IDW' 99, Proceedings of The Sixth International Display Workshops, AMD3-4, page 183-186, Dec. 1, 1999, sponsored by ITE and SID. In this case, as shown in FIG. 8, a pixel electrode is divided into a transmissive electrode 4t and a reflective electrode 4r, and a through hole 2H′ for the transmissive electrode 4t can be formed in the same way as for the above-described through hole 2H. That is, exposure, development and etching are likewise carried out using a halftone mask having a transmissive area corresponding to the through hole 2H′. In this way, a depression portion corresponding to this transmissive area, or a bottom portion is formed in the photosensitive material 2, and a through hole to cause the transmissive electrode 4t to be exposed to the exterior is formed on its bottom face. Then, the optical reflective material (4r) is formed on the base layer 20 in such a way as to be connected to the transmissive electrode 4t only at its ends, and only the reflective electrode 4r is thereby provided with a diffusive reflecting property, which due to the presence of the bottom portion (local optical transmissive area) of low height corresponding to the through hole 2H′ as compared to the base layer 20, reflected light Lr and transmitted light Lt handled by the liquid crystal display panel can be made to have the same optical path length.

The effects of the diffusive reflecting structure constructed as described above will be explained below.

FIG. 9 shows a distribution of reflected light of the diffusive reflecting structure as a comparative example and FIG. 10 shows a distribution of reflected light of the diffusive reflecting structure according to this embodiment. In these figures, x indicates the horizontal direction when the principal surface of the diffusive reflecting structure is viewed right from the front and y indicates the vertical direction, and intensity of reflected light obtained by assuming a normal to the principal surface which stands at the point of an object viewed right from the front as the origin and changing the viewing angle relative to the normal is expressed by three contour lines. Both figures show that at the viewing angle of an area closer to the origin, the contour represents reflected light of higher intensity.

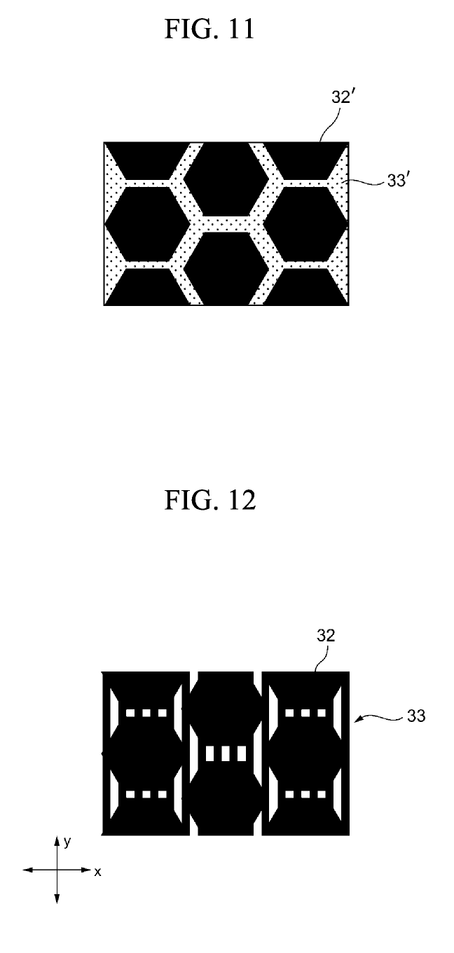

In the diffusive reflecting structure in the comparative example, the depression and projection portions 21, 22 are formed in such a way as to diffuse and reflect light uniformly in all directions and the above-described micro depression and projection portions 23, 24 are not formed in the depression portion 21. The photomask used to form such a reflecting structure has a form as shown in FIG. 11. In the plane structure of the photomask shown in FIG. 11, light shield areas 32′ are distributed in a mesh-like form and a semitransmissive area 33′ extends in a net-like form surrounding these light shield areas. Unlike the embodiment, the semitransmissive area 33′ is formed with thickness and/or material different from those of other areas, which cause(s) incident light to transmit at a gray scale. It is noted that the mask pattern in FIG. 11 is shown with a portion corresponding to the transmissive area 31 omitted and the figure of the distribution of reflected light as shown in FIG. 9 is expressed quite schematically (the same will apply to the following). As is evident from FIG. 9, in the case of this comparative example, the distribution of reflected light is uniform in all directions.

In contrast to this, the diffusive reflecting structure having the micro depression and projection portions 23, 24 of this embodiment exhibits a distribution of reflected light which is generally dominant at viewing angles in the x-direction as shown in FIG. 10. This is based on the fact that the longitudinally extending direction of the micro depression and projection portions 23, 24 is the y-direction. This causes reflected light of high intensity to be obtained in a viewing angle range in the x-direction and if this reflected light is used for display, the viewer sees a bright displayed image in this direction. For example, if the x-direction is the horizontal direction of the principal surface of the diffusive reflecting structure, a relatively bright displayed image can be obtained even when the principal surface of the reflecting structure is swung in the horizontal direction from the state of viewing right from the front. On the contrary, the diffusive reflecting structure has a distribution of reflected light which is inferior in the y-direction, and therefore reflected light of low intensity is obtained in the viewing angle range in the y-direction and it is possible to darken the displayed image. This embodiment adopts the mask pattern shown in FIG. 12 instead of the mask pattern of FIG. 11.

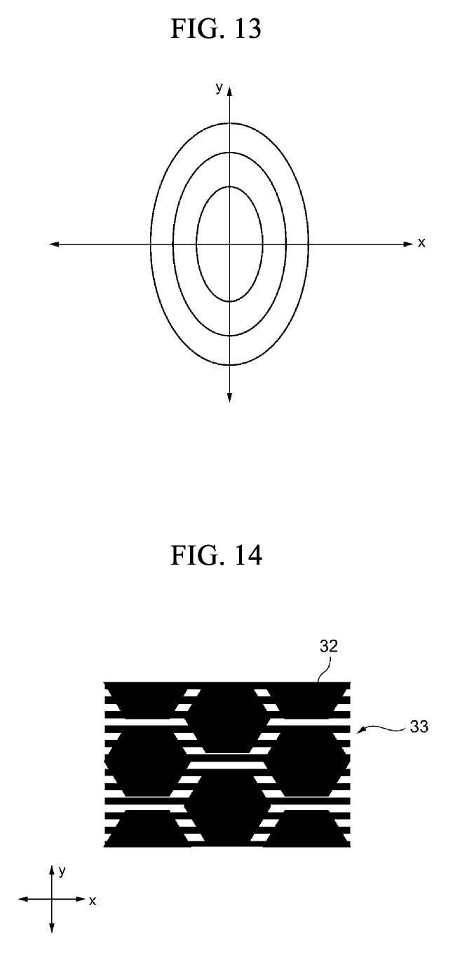

When the longitudinally extending direction of the micro depression and projection portions 23, 24 is changed to the x-direction, the distribution looks like FIG. 13. Thus, a directivity which is different from the one in FIG. 10 is obtained. If the x-direction is the horizontal direction of the principal surface of the diffusive reflecting structure, relatively bright reflected light can be obtained even when the principal surface of the reflecting structure is swung in the vertical direction from the state of viewing right from the front. For this modification example, a mask pattern as shown in FIG. 14 is adopted.

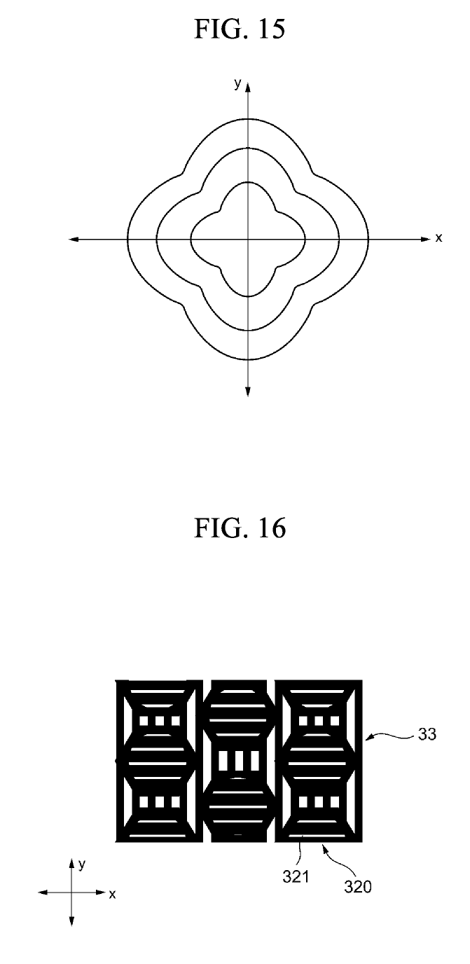

FIG. 15 shows a further directivity. Such a directivity is obtained by separating areas where the micro depression and projection portions 23, 24 extend in the x-direction and areas where the micro depression and projection portions 23, 24 extend in the y-axis direction in the principal surface of the diffusive reflecting structure and distributing and arranging these areas over the entire principal surface.

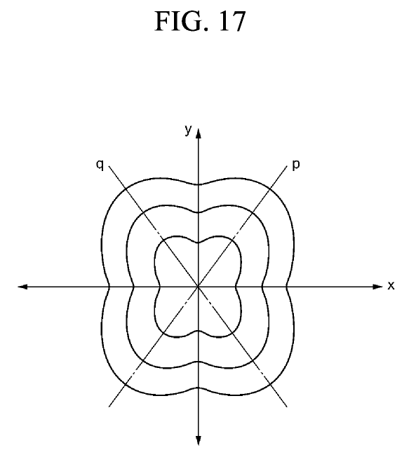

Alternatively, the directivity can also be realized by forming the micro depression and projection portions 23, 24 not only in the bottom portion 22 but also in the peak portion 21 and causing the extending direction of the micro depression and projection portions in one of the bottom and peak portions to perpendicularly intersect the extending direction of the micro depression and projection portions in the other of the bottom and peak portions. FIG. 16 shows the structure of the halftone mask used in such a case and the light shield area 320 is provided with a transmissive linear part 321 which extends perpendicular to the extending direction of the linear part of the semitransmissive area 33 and which is narrower in width than the linear part of the semitransmissive area, and this linear part 321 and the light shield part other than the part 321 cause the peak portion of the base layer to be provided with micro unevenness.

FIG. 17 is a modification example of the structure in FIG. 15 and is realized by causing the extending direction of the micro depression and projection portions of the bottom portion 22 and the extending direction of the micro depression and projection portions of the peak portion 21 to extend in the diagonal direction and cross each other. This example is achieved by making the micro depression and projection portions to extend in the directions perpendicular to axes p and q, respectively in directions of which dominance should be made in the distribution of reflected light. As is evident from this example, such two extending directions need not always be perpendicular to each other but may have a predetermined angle.

By causing the linear part 321 in the mask pattern shown in FIG. 16 to extend in the same direction as that of the linear part of the semitransmissive area 33, it is possible to obtain a distribution in which the dominance in the distribution of reflected light in FIG. 10 is further enhanced.

The diffusive reflecting structure obtained as in the foregoing is applicable to various types of display devices. For example, it is applicable not only to the reflection structure of the above-described semitransmissive type liquid crystal display panel but also to a component having a function of diffusively reflecting light corresponding to the image to be displayed in the display device.

In the above-described embodiment, a positive type photosensitive material 2 is used, but the photosensitive material 2 may also be of a negative type. In this case, the transmissive area and the light shield area of the halftone mask are reversely arranged. Furthermore, the through hole need not always be formed, and peak portions and halfway portions need to be formed in the base layer at a minimum requirement. Furthermore, when peak portions, halfway portions and bottom portions are formed as a principal uneven pattern in the base layer, the present invention does not necessarily exclude a form in which fine unevenness is formed in the bottom portion.

Furthermore, in the foregoing, transmittances of the first linear part 34 and second linear part 35 are substantially 100% and 0% respectively, but combinations of other values may also be used.

Representative embodiments and modification examples of the present invention have been described in the above, but the invention is not limited to them, and those skilled in the art can find various modifications within the scope of the attached claims.

### LIST OF REFERENCE NUMERALS

1 . . . glass substrate
11 . . . source electrode layer
12 . . . drain electrode layer
13 . . . semiconductor layer
14 . . . insulating layer
15 . . . gate electrode layer
2 . . . photosensitive material
20 . . . base layer
21 . . . projection portion
22 . . . depression portion
23 . . . microprojection portion
24 . . . microdepression portion
2H, 2H′ . . . through hole
3 . . . photomask
31 . . . transmissive area
32, 320 . . . light shield area
321 . . . transmissive linear part
33 . . . semitransmissive linear part
34 . . . first linear part
35 . . . second linear part
4 . . . optical reflective material
4r . . . reflective electrode
4t . . . transmissive electrode

1. A manufacturing method for a diffusive reflecting structure, comprising:
a first step of depositing a photosensitive material on a base layer;
a second step of masking the photosensitive material using a halftone mask having at least one of transmissive area and light shield area and having a semitransmissive area;
a third step of forming unevenness on a surface of a layer of the photosensitive material for providing an optical diffuse reflecting property by exposing the photosensitive material to light through the mask and developing the material, the unevenness corresponding to peak portions corresponding to the one of the transmissive area and light shield area and halfway portions corresponding to the semitransmissive area; and
a fourth step of depositing an optical reflecting material on the formed uneven surface,
wherein the halftone mask comprises a stripe arrangement-portion in the one or both of the transmissive area and light shield area and/or in the semitransmissive area in order to transmit the incident light at a gray scale, the stripe arrangement portion having first linear parts capable of transmitting the incident light at a relatively high first transmittance and second linear parts capable of intercepting the incident light at a relatively low second transmittance, the first linear parts and the second linear parts being placed in parallel with each other alternately, and
a surface of a layer of the photosensitive material, corresponding to the stripe arrangement portion, is provided with small-scale bottom portions corresponding to ones of the first and second linear parts and small-scale peak portions corresponding to the others.

2. A manufacturing method as defined in claim 1, wherein a surface of a layer of the photosensitive material is also provided with a bottom portion corresponding to the other of the transmissive area and light shield area in the third step.

3. A manufacturing method as defined in claim 2, wherein the base layer includes a layer forming a transistor, other active element or signal transmission path, the photosensitive material is electrically insulative, the bottom portion forms a through hole for causing a signal output electrode of the active element or the signal transmission path to be exposed to the exterior and/or a local optical transmissive area of the reflecting structure, and the optical reflecting material is electrically conductive.

4. A manufacturing method as defined in claim 1, 2 or 3, wherein linear parts of the stripe arrangement portion extend in a direction perpendicular to a direction in which dominance should be made in distribution of diffuse reflection of the diffusive reflecting structure.

5. A manufacturing method as defined in claim 1 any one of claims 44, wherein linear parts of the stripe arrangement portion in at least one of the transmissive area and light shield area and linear parts of the stripe arrangement portion in the semitransmissive area extend in parallel with or perpendicularly to each other or at predetermined angles.

6. A diffusive reflecting structure, comprising:
a layer of a photosensitive material that is formed integrated on a base layer and has a surface with uneven pattern representing peak portions and valley portions for providing an optical diffuse reflecting property; and
a layer of an optical reflective material deposited on the surface with the uneven pattern,
wherein at least one of the peak portion and valley portion is provided with linear small-scale bottom portions and small-scale peak portions formed in parallel with each other alternately.

7. A diffusive reflecting structure as defined in claim 6, wherein the base layer includes a layer forming a transistor, other active element or signal transmission path, the photosensitive material is electrically insulative, the valley portion includes a through hole for causing a signal output electrode of the active element or the signal transmission path to be exposed to the exterior and/or a portion forming a local optical transmissive area of the reflecting structure, and the optical reflecting material is electrically conductive.

8. A diffusive reflecting structure as defined in claim 6, wherein the small-scale bottom portions and peak portions extend in a direction perpendicular to a direction in which dominance should be made in distribution of diffuse reflection of the diffusive reflecting structure.

9. A diffusive reflective structure as defined in claim 6, wherein the small-scale bottom portions and peak portions in the peak portion and the small-scale bottom portions and peak portions in the valley portion extend in parallel with or perpendicularly to each other or at predetermined angles.

10. A display device using a diffusive reflecting structure manufactured in a method as defined in claim 1, wherein the diffusive reflecting structure functions as diffusive reflection of light according to an image to be displayed in the display device.

11. A display device using a diffusive reflecting structure manufactured in a method as defined in claim 1, wherein the layer of optical reflective material serves as a row or column electrode, common electrode, or pixel electrode.

12. A display device using a diffusive reflecting structure as defined in claim 6, wherein the diffusive reflecting structure functions as diffusive reflection of light according to an image to be displayed in the display device.

13. A display device using a diffusive reflecting structure as defined in claim 6, wherein the layer of optical reflective material serves as a row or column electrode, common electrode, or pixel electrode.

14. A display device using a diffusive reflecting structure manufactured in a method as defined in claim 10, wherein the layer of optical reflective material serves as a row or column electrode, common electrode, or pixel electrode.
